(19) United States
(12) Patent Application Publication
(10) Pub. No.: US 2004/0088497 A1
(43) Pub. Date: May 6, 2004

(54) Methods and apparatus for exchanging data using cyclic redundancy check codes

(76) Inventors: Russell C. Deans, Durham, NC (US); Troy S. Dahlmann, Raleigh, NC (US)

Correspondence Address: Burns, Doane, Swecker & Mathis, L.L.P., P.O. Box 1404, Alexandria, VA, 22313-1404, US

(21) Appl. No.: 10/288,741

(22) Filed: Nov. 6, 2002

(51) Int. Cl. G06F 12/00

(52) U.S. Cl. 711/146; 711/154

(57) ABSTRACT

Methods and apparatus for exchanging cyclic redundancy check encoded (CRC-encoded) data are presented. An exemplary arrangement includes at least two blocks connected by an address bus and a data bus on which data is exchanged between the blocks. A snoop block, connected to the address and data buses, is configured to receive an address from the data bus. The snoop block includes address masking circuitry configured to mask off the address receivable from the data bus to generate at least one snoop address. A CRC block, connected to the data bus and to the snoop block, is configured to generate a CRC code from the data when a data address, carried on the address bus, matches the at least one snoop address.

### BACKGROUND

What is described are methods and apparatus for exchanging data using cyclic redundancy check (CRC) codes. In particular, methods and apparatus for automatically generating CRC codes using address snooping are presented.

Error correction codes provide a way of detecting and correcting data errors introduced by a transmission channel. Two main categories of error correction codes are block codes and convolutional codes. Both types of codes introduce redundancy into the data stream by adding parity symbols to the transmitted data. The parity symbols are used to detect and then correct errors in the received data stream.

Most block codes in use today are cyclic codes or are closely related to cyclic codes. This is because cyclic codes employ an algebraic structure that enables the encoding/decoding functions to be easily implemented using simple linear feedback shift registers (LFSRs), avoiding the more complex and costly standard array type of decoder.

Cyclic codes are best described when the code vectors are interpreted as polynomials. In a cyclic code, all code word polynomials are multiples of a so-called generator polynomial g(x) of degree k−n, where k is the number of information bits contained in the message being error-coded. This polynomial is chosen to be divisible such that a cyclic shift of a given code vector yields a different code vector, hence the name cyclic code. A message polynomial m(x) is mapped to a code word polynomial c(x) according to the relationship: c(x)=m(x)*g(x).

CRC codes are a subset of cyclic codes and use a binary alphabet of “0” and “1”. Code word arithmetic may be based, for example, on modulo-2 addition (logical XOR) and modulo-2 multiplication (logical AND). In a typical CRC coding scheme, systematic codes are used, for example, codes having the convention that the leftmost code bit represents the highest degree in the polynomial. Thus, the code word polynomial c(x) may be written in its systematic form as: c(x)=m(x)*x^{n-k}+r(x), where r(x) is defined as the remainder of the division of x^{n-k} and the generator polynomial g(x) and represents the CRC bits added to the message. The transmitted message c(x) thus contains k information bits followed by n−k CRC bits.

Encoding a message using CRC codes involves first appending k bits to the message by multiplying m(x) and x^{n-k}, then appending any additional n−k CRC bits to the message that are calculated by dividing m(x)*x^{n-k} by g(x). Decoding involves first dividing the quantity c(x)*x^{n-k} by g(x), and then determining if the remainder of the division is zero. If the remainder is zero, then either no errors have been introduced by the channel or an undetectable error has been introduced.

CRC implementation can use either hardware or software methods. In the traditional hardware implementation, a CRC block including, among other things, a simple LFSR circuit, performs the necessary computations, processing the message data one bit at a time. The CRC block typically includes a data register that latches a number of bits of data (e.g., a byte) from a data bus used to generate the CRC code.

Conventionally, bytes of information transferred over a data bus between a central processing unit (CPU) and a peripheral block require two data bus accesses per byte of data transferred. One access results from the transfer of the data byte between the peripheral block and the CPU. The other access occurs between the CPU and CRC block to generate the required CRC code. This double access requirement reduces the data transfer efficiency by approximately fifty percent. Were it possible to automatically generate the CRC code needed to encode/decode the data, the transfer efficiency on the bus could be improved.

There is thus a need for improved techniques for generating CRC codes that will increase the overall transfer efficiency of data exchanged using CRC error coding.

### SUMMARY

Accordingly, one object is to provide methods and apparatus that will reduce the number of data bus accesses required to transfer information using CRC codes, thereby increasing the overall transfer efficiency on the bus. Another object is to provide methods and apparatus that automatically generate CRC codes for information being exchanged on a data bus. These objects are addressed by methods and apparatus for automatically generating CRC codes using address snooping techniques.

According to one aspect, an arrangement includes at least two blocks connected by an address bus and a data bus on which data is exchanged between the blocks. A snoop block, connected to the address and data buses, is configured to receive an address from the data bus. The snoop block includes address masking circuitry configured to mask off the address receivable from the data bus to generate at least one snoop address. A CRC block, connected to the data bus and to the snoop block, is configured to generate a CRC code from the data when a data address, carried on the address bus, matches the at least one snoop address.

According to another aspect, an apparatus for automatically generating cyclic redundancy check (CRC) codes from data being exchanged on a data bus includes an address register, connected to the data bus, configured to store an address receivable from the data bus. Address masking circuitry is configured to mask off the address receivable from the data bus to generate at least one snoop address. Address compare circuitry, connected to the address register, to an address bus, and to a CRC block by at least one control signal, is configured to compare the at least one snoop address with a data address carried on the address bus, and to command the CRC block via the at least one control signal to generate a CRC code from the data when the data address matches the at least one snoop address.

According to another aspect, a method for automatically generating cyclic redundancy check (CRC) codes from data being exchanged on a data bus includes storing an address receivable from the data bus. The stored address is masked off to generate at least one snoop address. The at least one snoop address is compared with a data address of the data being exchanged on the data bus. The data being exchanged over the data bus is captured when the data address matches the at least one snoop address. A CRC code is then generated from the captured data.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

### BRIEF DESCRIPTION OF THE DRAWINGS

The above objects, features, and advantages will become more apparent in light of the following detailed description in conjunction with the drawings, in which like reference numerals identify similar or identical elements, and in which:

FIG. 1 is a block diagram depicting a system for automatically generating CRC codes according to an exemplary embodiment; and

FIG. 2 is a flow diagram depicting a method for automatically generating CRC codes according to an exemplary embodiment.

### DETAILED DESCRIPTION

Preferred embodiments are described below with reference to the accompanying drawings. In the following description, well-known functions and/or constructions are not described in detail to avoid obscuring the description in unnecessary detail.

Applicants have discovered that by knowing the address of data to be error coded in advance of its transfer over a data bus (or at least contemporaneous with the data transfer), the address information may be compared with a current write and/or read address of the data, and then appropriate action taken to automatically generate a CRC code for the data block. This eliminates the need to independently transfer the data to/from a CRC code generator.

One technique for obtaining this address information is by “snooping” the address bus during certain bus operations (e.g., read and/or write operations). Address snooping is a technique of passively monitoring the address bus, and then taking certain action depending on the current value carried on the bus. The techniques described herein employ address snooping to allow data to be automatically loaded into a CRC generation block for generating CRC codes.

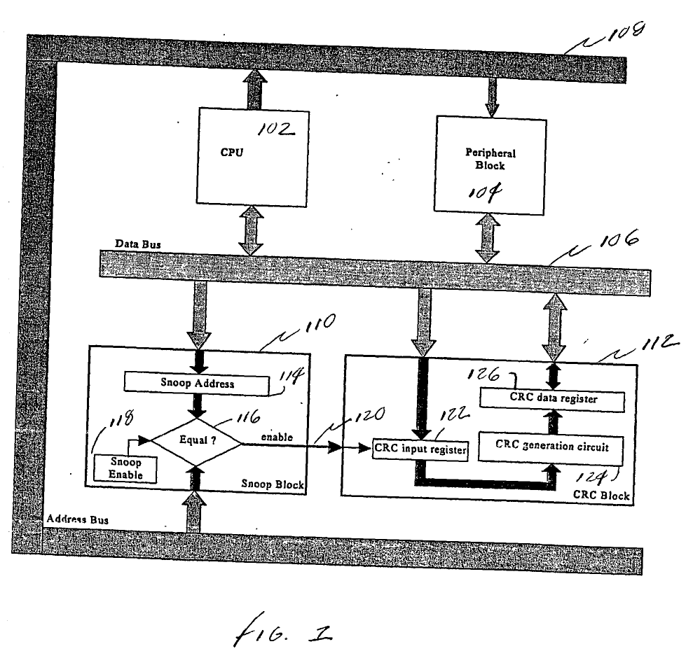

An exemplary block diagram depicting a computing system for generating CRC codes using address snooping is shown in FIG. 1. The exemplary computing system shown includes a CPU 102 and a peripheral block 104. The CPU 102 and peripheral block 104 are connected together by both a data bus 106 and by an address bus 108. Typical computing systems may include several additional peripheral blocks (not shown) that are connected to the data and address buses 106, 108.

For exemplary purpose, the peripheral block 104 can be considered a serial input/output device (or SIO), although the concepts described herein can be applied to any type of device connected to the data and address buses 106/108. The CPU 102 commands the transfer of data to/from the peripheral block 104 and to/from a CRC block 112 that generates the required CRC code to append to the transferred data. As discussed above, conventionally the CPU 102 commands the separate transfer of data both to/from the peripheral block 104, as well as to/from the CRC block 112, to effect the desired CRC code generation. These two separate transfers cause data bus transfer inefficiencies to arise.

To address these inefficiencies, the computing system shown in FIG. 1 further includes an address snoop block 110. The address snoop block 110 is connected to both the data and address buses 106, 108. The snoop block 110 includes a snoop address register 114 connected to the data bus 106. The snoop address register 114 may be a single register or may include a bank of registers used to store the address(es) of data for which CRC codes are to generated by the CRC block 112. The CPU 102 loads the snoop address register 114 by placing the desired snoop address on the data bus 106 with the appropriate address of the snoop address register 114 being written to the address bus 108.

The snoop block 110 further includes address compare circuitry 116 connected to both the snoop address register 114 and to the address bus 108. The address compare circuitry 116 is capable of determining whether the address(es) stored in the address register 114 matches the current address carried on the address bus 108. The address compare circuitry 116 includes address bit masking logic (not shown) that is capable of “masking off” a number of bits of the address stored in the snoop address register 114. Such an arrangement permits a single stored snoop address to represent the data stored at several physical address locations (e.g., a block of address locations).

For example, given a snoop address register 114 of eight bits, the bit masking logic of the address compare circuitry 116 may be configured such that only the four most significant bits (MSBs) of the address stored in the snoop address register 114 and the address carried on the address bus 108 are compared. In other words, the four least-significant bits (LSBs) are “masked off” during the address comparison.

When the address(es) stored in the snoop address register 114 matches the current address carried on the address bus 108, the address compare circuitry 116 can activate a CRC enable signal 120 connected between the address compare logic 116 and the CRC block 112. The snoop block 110 may further include CPU programmable control logic 118 used to enable/disable the address compare logic 116.

When the snoop address enable/disable logic 118 is configured to enable the address compare logic 116, the CRC enable signal 120 will be activated whenever the address stored in the snoop address register 114 matches the current address stored on the address bus 108. When the snoop address enable/disable logic 118 is configured to disable the address compare logic 116, the CRC enable signal 120 will not be activated, even when the address stored in the snoop address register 114 matches the current address stored on the address bus 108. The snoop address enable/disable logic 118 may be configured to enable/disable the address compare logic 116 whenever, e.g., write operations, read operations, or both write and read operations occur in the system.

The CRC block includes a CRC input register 122 that is connected to both the CRC enable signal 120, produced by the address compare logic 116, and to the data bus 106. As described above, provided the address compare logic 116 is enabled, the CRC enable signal 120 will be activated whenever the address stored in the snoop address register 114 matches the current address carried on the address bus 108. Activation of the CRC enable signal 120 causes the data currently carried on the data bus 106 to be latched into the CRC input register 122. The data latched into the CRC input register 122 is then passed to the CRC generation circuitry 124, connected to the CRC input register 122, that generates the necessary CRC code for the data. The generated CRC code is then passed to a CRC data register 126 that is connected to the CRC generation circuitry 124. The CRC data register is further connected through a bi-directional bus to the data bus 106, thus allowing the generated CRC code to be passed or read via the data bus 106 for error-checking purposes.

With the above-described arrangement that combines CRC generation with address snooping capability, data that is to be CRC error-coded need not be directly written to the CRC block 112 in order to generate the required CRC code. Instead, the described arrangement enables the CRC block 112 to automatically latch data already residing on the data bus 106 for CRC code generation whenever the data is being read from or written to peripheral blocks or SIOs corresponding to a particular address or group of addresses in the system.

Without the address snooping capability, the CPU 102 would have to command the data to be written twice to effect transmission over the data bus 106: once to the peripheral block 104 for transmission, and a second time to the CRC block 112 for generation of the needed CRC code. Thus, “snooping” the address(es) of data exchanged between blocks in the system enables the data to be automatically loaded into the CRC block 112, reducing the bus bandwidth requirements for system applications by up to fifty percent (e.g., in systems that read the data to be written to the peripheral block 104 and CRC block 112 twice).

Preferably, the snoop block 110 and CRC block 112 are implemented as stand-alone blocks so that they can be used independently by any peripheral block 104 that the CPU 102 reads data from or writes data to in the system. But this need not be the case, and the functions of these two blocks could be integrated into a signal snoop/CRC block (not shown).

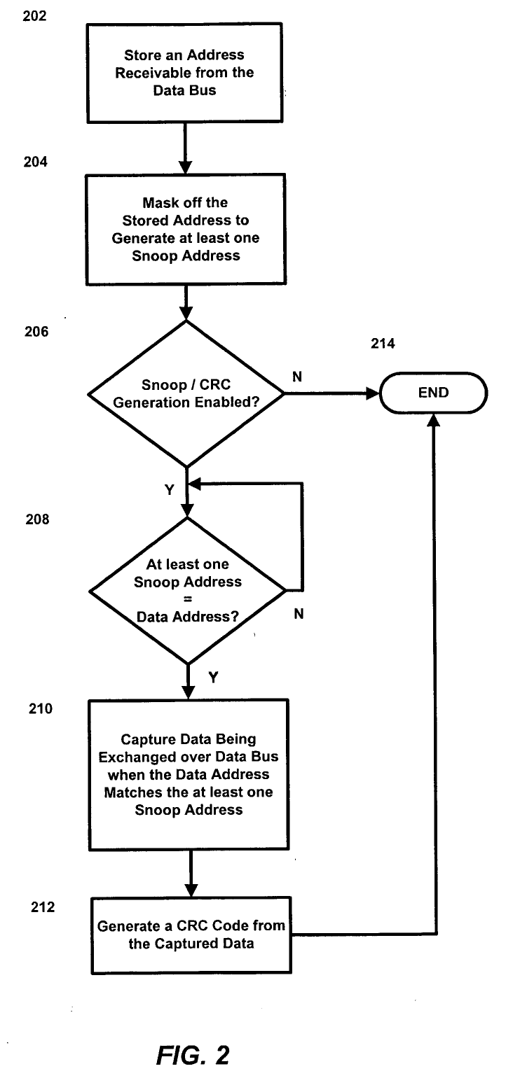

A flow chart describing an exemplary method for generating CRC codes is shown in FIG. 2. While the steps of the method are described with reference to the blocks of the exemplary arrangement shown in FIG. 1, it will be understood by those skilled in the art that other arrangements may be used to practice the described method.

The method begins at step 202, where the address(es) corresponding to the location(s) of data for which CRC codes are to be generated, e.g., into the snoop address register 114 of the snoop block 110. Recall that one or several addresses may be stored in the snoop address register 114. The method next proceeds to step 204, where the stored address is masked off to generate at least one snoop address. Recall that a number of bits of the stored address, e.g., in the snoop address register 114, can be “masked off”, enabling a single stored address to represent the data stored at several physical address locations (e.g., a block of address locations) in the system.

In step 206, a determination is made as to whether address snooping/CRC code generation is enabled or disabled. If disabled, no further processing of the data is performed, and the procedure ends at step 214. But, the CPU 102 could command that the data still be written directly to the CRC input register 122 for “manual” generation of the CRC code. Whether address snooping/CRC code generation is enabled or disabled may be directly configured, e.g., by the CPU 102, or may depend upon whether certain operations, e.g., write and/or read operations, occur in the system. If enabled, the routine proceeds to step 208.

In step 208, a determination is made as to whether the data address, e.g., carried on the address bus 108, matches the at least one snoop address, e.g., generated by the address masking circuitry (not shown). If an address match does not occur, then the procedure returns to step 206 until an address match is detected. Once an address match is detected, the routine proceeds to step 210, where data currently being carried on the data bus 106 is captured, e.g., by being latched into the CRC input register 122 of the CRC block 112.

Once captured, e.g., by being latched into the CRC input register 122, the data is next processed by the CRC generation circuitry 124 at step 212, where the necessary CRC code to error-code the data is generated. The generated CRC code is available for error coding/checking purposes via the data bus 106. Once the CRC code is generated, the procedure ends at step 214.

It will be appreciated that the steps of the methods illustrated above may be readily implemented either by software that is executed by a suitable processor or by hardware, such as an application-specific integrated circuit (ASIC).

Various aspects have been described in connection with a number of exemplary embodiments. To facilitate an understanding of these embodiments, many aspects were described in terms of sequences of actions that may be performed by elements of a computer system. For example, it will be recognized that in each of the embodiments, the various actions could be performed by specialized circuits (e.g., discrete logic gates interconnected to perform a specialized function), by program instructions being executed by one or more processors, or by a combination of both.

Moreover, the exemplary embodiments can be considered part of any form of computer readable storage medium having stored therein an appropriate set of computer instructions that would cause a processor to carry out the techniques described herein. Thus, the various aspects may be embodied in many different forms, and all such forms are contemplated to be within the scope of what has been described. For each of the various aspects, any such form of embodiment may be referred to herein as “logic configured to” perform a described action, or alternatively as “logic that” performs a described action.

Although various exemplary embodiments have been described, it will be understood by those of ordinary skill in this art that these embodiments are merely illustrative and that many other embodiments are possible. The intended scope of the invention is defined by the following claims rather than the preceding description, and all variations that fall within the scope of the claims are intended to be embraced therein.

What is claimed is:

1. An arrangement for exchanging data using cyclic redundancy check (CRC) codes, comprising:
at least two blocks connected by an address bus and a data bus on which data is exchanged between the blocks;
a snoop block, connected to the address and data buses, configured to receive an address from the data bus, the snoop block including:
address masking circuitry configured to mask off the address receivable from the data bus to generate at least one snoop address; and
a CRC block, connected to the data bus and to the snoop block, configured to generate a CRC code from the data when a data address, carried on the address bus, matches the at least one snoop address.

2. The arrangement of claim 1, wherein the snoop block is connected to the CRC block by at least one control signal capable of commanding the CRC block to generate the CRC code from the data on the data bus when the data address matches the at least one snoop address.

3. The arrangement of claim 2, wherein the snoop block comprises:
a snoop address register, connected to the data bus and to the address masking circuitry, configured to store the address receivable from the data bus; and
address compare circuitry, connected to the address masking circuitry, to the address bus, and to the CRC block by the at least one control signal, configured to compare the data address with the at least one snoop address, and to command the CRC block via the at least one control signal to generate the CRC code from the data when the data address matches the at least one snoop address.

4. The arrangement of claim 3, wherein the snoop address register is configured to store more than one address.

5. The arrangement of claim 3, wherein the snoop block further comprises:
enable/disable circuitry, connected to the address compare circuitry, configured to enable the address compare circuitry to command the CRC block to generate the CRC code when an address match occurs, and to disable the address compare circuitry from commanding the CRC block to generate the CRC code irrespective of whether the data address matches the at least one snoop address.

6. The arrangement of claim 5, wherein the enable/disable circuitry is configured to enable the address compare circuitry to command the CRC block to generate the CRC code whenever at least one of a write operation and a read operation occurs on the data bus.

7. The arrangement of claim 1, wherein the CRC block comprises:
a CRC input register connected to the data bus and to the snoop block;
CRC generation circuitry connected to the CRC input register; and
a CRC data register connected to the CRC generation circuitry and to the data bus.

8. The arrangement of claim 7, wherein the data exchanged between the blocks is loaded into the CRC input register from the data bus and is passed to the CRC generation circuitry that generates the CRC code when commanded by the snoop block, the generated CRC code then being passed to the CRC data register connected to the data bus.

9. The arrangement of claim 1, wherein at least one of the blocks is a direct memory access (DMA) controller.

10. The arrangement of claim 1, wherein at least one of the blocks is a central processing unit (CPU).

11. The arrangement of claim 10, wherein the CPU comprises:
logic configured to determine the at least one snoop address; and
logic configured to enable the CRC block to generate the CRC code when an address match occurs and configured to disable the CRC block from generating the CRC code irrespective of whether the data address matches the at least one snoop address.

12. An apparatus for automatically generating cyclic redundancy check (CRC) codes from data being exchanged on a data bus, comprising:
an address register, connected to the data bus, configured to store an address receivable from the data bus;
address masking circuitry configured to mask off the address receivable from the data bus to generate at least one snoop address; and
address compare circuitry, connected to the address register, to an address bus, and to a CRC block by at least one control signal, configured to compare the at least one snoop address with a data address carried on the address bus, and to command the CRC block via the at least one control signal to generate a CRC code from the data when the data address matches the at least one snoop address.

13. The apparatus of claim 12, wherein the address register is configured to store more than one address.

14. The apparatus of claim 12, further comprising:
enable/disable circuitry, connected to the address compare circuitry, configured to enable the address compare circuitry to command the CRC block to generate the CRC code when an address match occurs, and to disable the address compare circuitry from commanding the CRC block to generate the CRC code irrespective of whether an address match occurs.

15. The apparatus of claim 14, wherein the enable/disable circuitry is configured to enable the address compare circuitry to command the CRC block to generate the CRC code whenever at least one of a write operation and a read operation occurs on the data bus.

16. A method for automatically generating cyclic redundancy check (CRC) codes from data being exchanged on a data bus, the method comprising:
storing an address receivable from the data bus;
masking off the stored address to generate at least one snoop address;
comparing the at least one snoop address with a data address of the data being exchanged on the data bus;
capturing the data being exchanged over the data bus when the data address matches the at least one snoop address; and
generating a CRC code from the captured data.

17. The method of claim 16, further comprising:
enabling the generating of the CRC code from the captured data in response to a command signal having a first value when the data address matches the at least one snoop address; and
disabling the generating of CRC code from the captured data in response to the command signal having a second value irrespective of whether the data address matches the at least one snoop address.

18. The method of claim 17, further comprising the step of:
assigning the first value to the command signal when at least one of a write operation and a read operation occurs on the data bus.
